(19) United States
(12) Patent Application Publication
(10) Pub. No.: US 2006/0055984 A1
(43) Pub. Date: Mar. 16, 2006

(54) Image processing apparatus, image processing method and program

(75) Inventors: Jun Minakuti, Sakai-shi (JP); Atsushi Ueda, Ritto-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/049,500

(22) Filed: Feb. 2, 2005

(30) Foreign Application Priority Data
Sep. 14, 2004 (JP) JP2004-266798

(51) Int. Cl. H04N 1/40

(52) U.S. Cl. 358/448

(57) ABSTRACT

An image processing apparatus comprises a selecting part for selecting an objective image of image processing, a specifying part for specifying possible image processing details to be provided to the objective image, and a setting part for setting image processing details to be provided to the objective image based on the possible image processing details specified by the specifying part. When a plurality of items in image processing specified with the possible image processing details include both an item inapplicable to the objective image while being applicable to an image of a type different from the type of the objective image, and an item applicable to the objective image, the setting part applies the possible image processing details as image processing details to be provided to the objective image with respect only to the item applicable to the objective image.

This application is based on application No. 2004-266798 filed in Japan, the contents of which are hereby incorporated by reference.

### BACKGROUND OF THE INVENTION

1. Field of the Invention

The present invention relates to an image processing technique and more particularly, to a technique for use in various types of image processes on a plurality of images.

2. Description of the Background Art

Images captured for example by a digital camera have been subjected to an image processing technique for performing image processes with respect to a variety of items including color balance correction, brightness correction and the like. More specifically, these image processes are performed by executing a certain program for image processing on a personal computer. Such an image processing technique provides an improved image quality.

When similar image processes are repeatedly performed on a plurality of images, by executing one of software programs responsible for these processes, the image processing details (set values) of one image are copied and applied (pasted) as the image processing details to be provided to another image. In contrast to the case in which parameters of image processing details are specified for each image, this provides savings in manual setting to result in improved operability.

Wide-ranging captured images include not only images of general-purpose formats such as JPEG or TIFF images but also include images of the RAW format directly recording output information from an imaging device (an image sensor).

In the foregoing technique, copy-and-paste editing of image processing details is allowed between images of the same type, whereas between images of different types, copy-and-paste editing is not realized. That is, setting operations of image processing details by copy-and-paste editing is allowed only when a source image of copy editing and a destination image of paste editing are of the same type. In other words, setting operations of image processing details by copy-and-paste editing is not allowed when a source image and a destination image are of different types.

When a plurality of images of different types are subjected to image processing in the foregoing technique, processing parameters of image processing should be individually set for each image, or the foregoing copy-and-paste editing is required for each type of image, resulting in reduction of working efficiency. An environment including a mixture of these various types of images thus causes decreased working efficiency.

Differences of image types exist between various types of images as well as between an image of the RAW format and images of general-purpose formats such as a JPEG or TIFF image, in which case the same problem occurs.

Setting operations except copy-and-paste editing are also preferably performed with a high degree of efficiency in an environment including a mixture of various types of images.

### SUMMARY OF THE INVENTION

Even in an environment including a mixture of various types of images, it is an object of the present invention to provide a technique capable of achieving a high degree of efficiency in setting operations of processing details in image processing.

According to one aspect of the present invention, an image processing apparatus comprises: a selecting part for selecting an objective image of image processing; a specifying part for specifying possible image processing details to be provided to the objective image; and a setting part for setting image processing details to be provided to the objective image based on the possible image processing details specified by the specifying part. When a plurality of items in image processing specified with the possible image processing details include both an item inapplicable to the objective image while being applicable to an image of a type different from the type of the objective image, and an item applicable to the objective image, the setting part applies the possible image processing details as image processing details to be provided to the objective image with respect only to the item also applicable to the objective image.

The present invention is also directed to an image processing method and a program product.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of an image processing apparatus;

FIG. 2 is a functional block diagram of the image processing apparatus;

FIG. 3 shows an operation screen during execution of a program;

FIG. 4 shows another operation screen;

FIG. 5 shows a plurality of items in image processing;

FIG. 6 shows a setting dialog;

FIG. 7 is a flow chart explaining processing in the image processing apparatus;

FIG. 8 shows a data table indicating the applicability of image processing with respect to each item to each image type; and

FIG. 9 shows exemplary setting of image processing details.

### DESCRIPTION OF THE PREFERRED EMBODIMENTS

A preferred embodiment of the present invention will be discussed below with reference to drawings.

<Configuration>

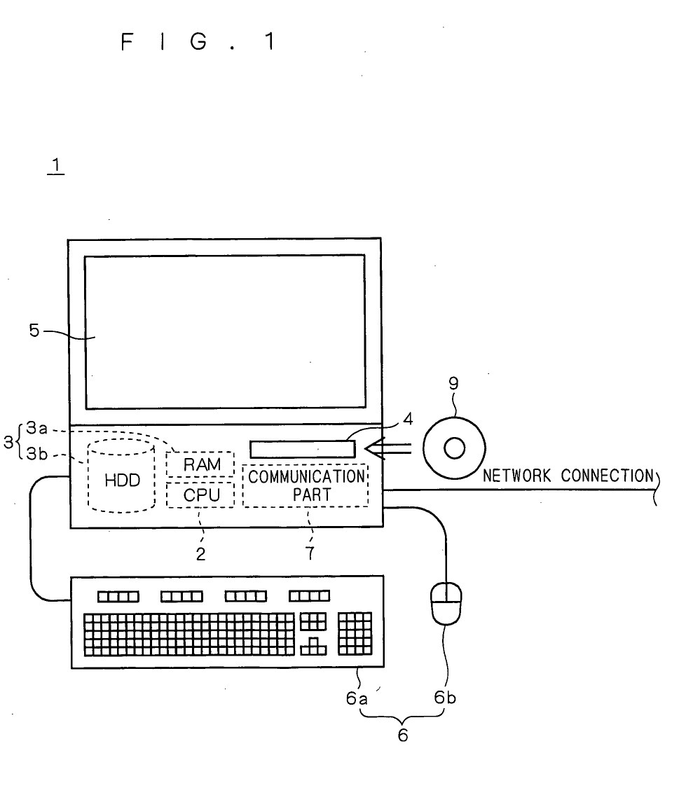

FIG. 1 is a schematic view of an image processing apparatus according to a preferred embodiment of the present invention. As seen from FIG. 1, the image processing apparatus 1 is configured as a computer system (hereinafter also simply referred to as a “computer”). More specifically, this computer (image processing apparatus) comprises a CPU 2, a storage part 3, a media drive 4, a display part 5 which may be a liquid crystal display, an input part 6 including for example a keyboard 6a and a mouse 6b, and a communication part 7 which may be a network card. The storage part 3 has a main storage 3a including a semiconductor memory such as a RAM, and an auxiliary storage 3b which may be a hard disk drive (HDD). The media drive 4 is capable of reading information stored in a portable recording medium 9 which may be a CD-ROM, DVD (digital versatile disk), flexible disk, memory card or the like.

The image processing apparatus 1 reads a software program PG (hereinafter also simply referred to as a “program”) stored in the recording medium 9 and causes for example the CPU 2 to execute the program PG, thereby becoming operative to perform various functions discussed later. The program realizing each function is not necessarily supplied from the recording medium 9. This program may alternatively be supplied to the computer through a network such as a LAN or the Internet.

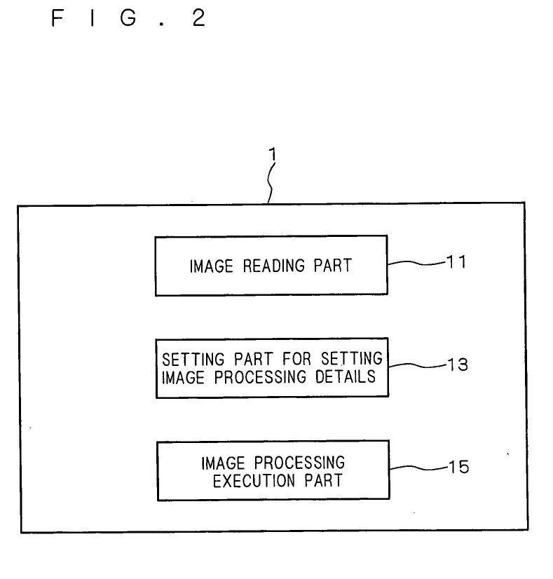

FIG. 2 is a functional block diagram of the image processing apparatus 1. With reference to FIG. 2, the image processing apparatus 1 comprises an image reading part 11, a setting part 13 for setting image processing details, and an image processing execution part 15.

The image reading part 11 serves to read data of an image to be processed in a manner capable of being handled in the program PG. The setting part 13 serves to set image processing details with respect to a plurality of items (to be discussed later). Image processing details on each image with respect to a plurality of items are stored in a storage area under management of the program PG. The image processing execution part 15 serves to actually perform image processing with respect to each item based on the image processing details set by the setting part 13.

The setting part 13 copies image processing details related to one image and pastes the copied details to an objective image (copy-and-paste editing) to set the image processing details to be provided to the objective image. Thus, image processing details are not required to be reset for each item, whereby a plurality of images can be subjected to similar processes by considerably simple operations.

In the image processing apparatus 1, items capable of being shared between a plurality of different types of images are copied to set the image processing details to be provided to images even of different types. As an example, with respect to an item applicable both to an image of the RAW format and to a JPEG image, image processing details can be set by copy editing (see FIG. 9). Thus, images of different types can be easily given similar image processing details by considerably simple operations to realize image processing.

Next, the foregoing processing will be discussed in more detail.

<Operations>

When images PA and PB are to be processed in this order, it will be described how the image processing details to be provided to the latter image PB are set using the image processing details of the former image PA. More specifically, such setting is easily realized by (1) specification of a parameter of each one of a plurality of items related to the predetermined image PA to set the image processing details thereof, and thereafter, (2) copy editing of the image processing details related to the image PA and paste editing thereof as the image processing details to be provided to the different image PB. In the following, the images PA and PB are also referred to as “source image of copy editing” and “destination image of paste editing (or objective image), respectively.

First, the operations (1) to perform image processing on the image PA and the like will be discussed.

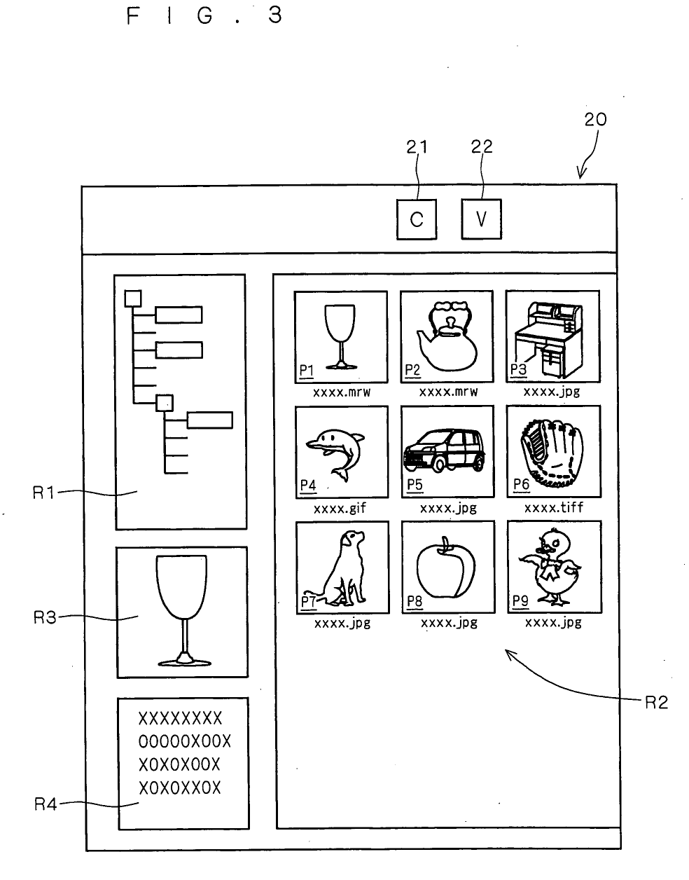

FIG. 3 shows an operation screen 20 during execution of the program PG.

The operation screen 20 is divided into a plurality of regions including R1, R2, R3 and R4. The region R1 is allocated for display of a folder tree, the region R2 is for image display, the region R3 is for preview display, and the region R4 is for information display.

When an operator specifies a certain folder by a mouse operation or the like, each image in the specified folder is thumbnail displayed in the region R2 while being identified by its file name. Alternatively, only file names of images may be listed.

When a desired image is selected from a plurality of images displayed in the region R2 (including images P1 through P9) by a mouse operation (which is more particularly a single-click), a preview screen of the selected image is displayed in the region R3 and various types of information such as tag information of the selected image is displayed in the region R4.

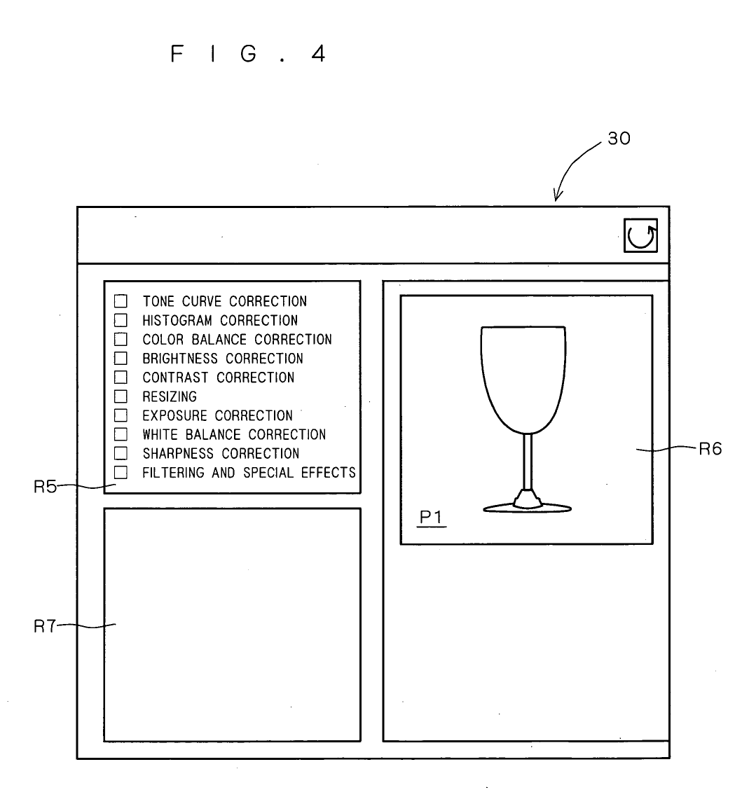

Making reference to the display contents in the regions R1 through R4, the operator selects the image PA (which may for example be the image P1) as a desirable target image for processing. More specifically, the operator selects the desired image PA from the images displayed in the region R2 by a double-click. In response to this selection, the image processing apparatus 1 recognizes the image PA (the image P1, for example) has been selected as a target image for processing, creates a new window, and displays an operation screen 30 (see FIG. 4) on the display part 5.

FIG. 4 shows the operation screen 30 for designating and implementing image processing details. With reference to FIG. 4, the operation screen 30 is divided into an item display region R5 in which a plurality of items in image processing are listed, an image display region R6 for displaying the selected image, and an information display region R7 for displaying detailed information of the selected image.

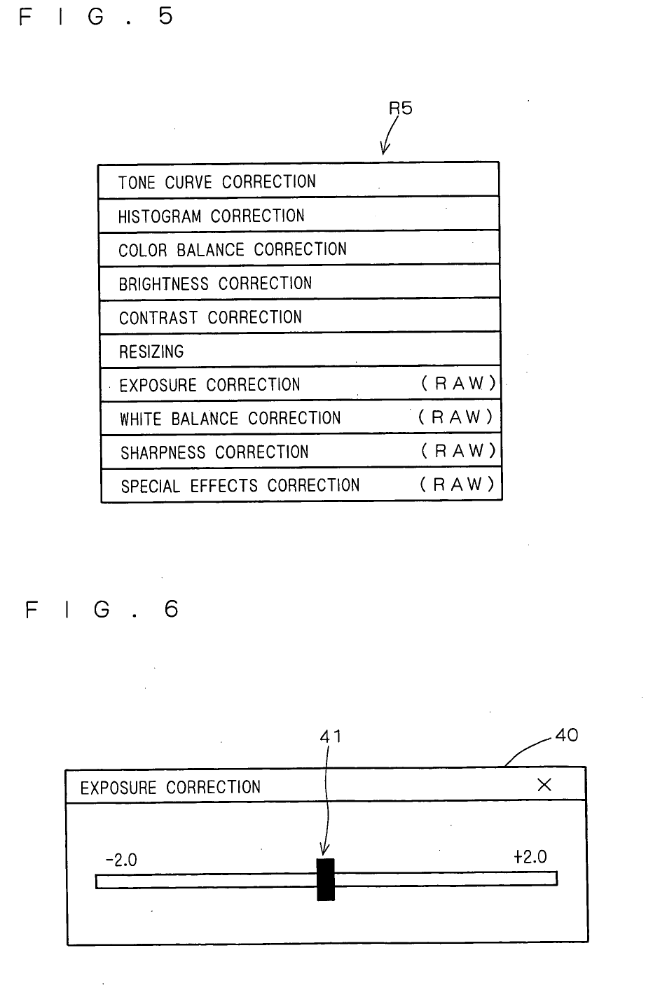

FIG. 5 shows a plurality of items displayed in the item display region R5. With reference to FIG. 5, as items in image processing, tone curve correction, histogram correction, color balance correction, brightness correction, contrast correction, resizing, exposure correction, white balance correction, sharpness correction and special effects correction are listed. As discussed below, the last four corrections (which more particularly include exposure correction, white balance correction, sharpness correction and special effects correction) are applicable only to the RAW format. Items in image processing are not limited to those shown in FIG. 5. Other items in image processing may be applied.

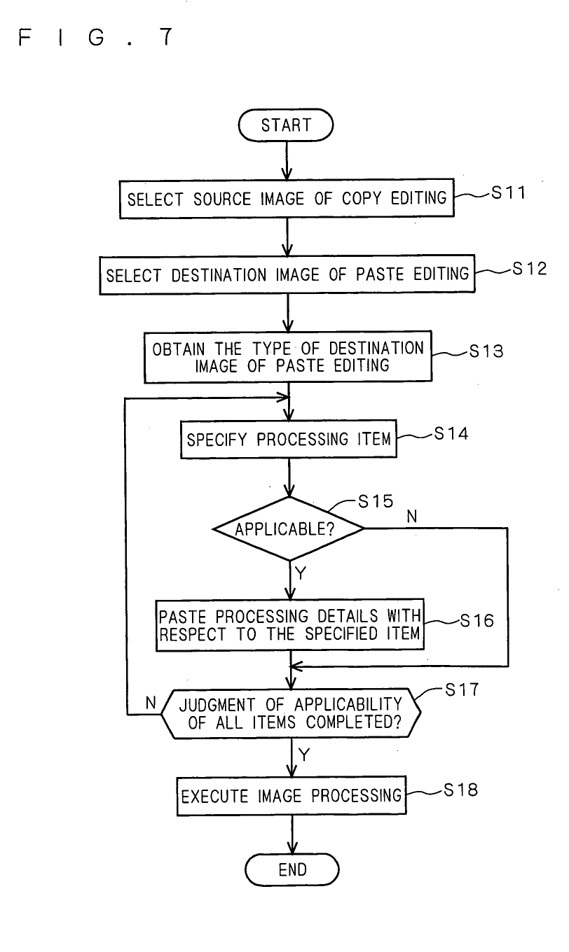

When a certain item in the region R5 is specified by a mouse operation (which is more particularly a double-click) on the operation screen 30 of FIG. 4, a setting dialog appears which sets the selected item in detail. As an example, when “exposure correction” is selected, a setting dialog 40 appears as shown in FIG. 6. The operator moves a slider 41 in the setting dialog 40 to the left and right by a mouse operation, whereby a parameter for exposure correction is allowed to have an arbitrary value ranging between −2.0 and +2.0. The image processing apparatus 1 performs image processing within the set parameter, and displays the image PA in the region R6 after correction according to this parameter.

The other items are subjected to the same setting. Image processing is performed according to a correction parameter suitably set for each item. The plurality of items are subjected to the same operation one by one by the operator, whereby the image processing details with respect to the plurality of items are set to perform image processing with respect to the plurality of items. When image processes with respect to desired items are all completed, the operator closes the operation screen 30. By the time the program PG ends, the image processing details of the image PA are stored in the storage part 3 under management of the program PG.

Following the flow discussed above, the image PA is subjected to image processing.

Next, the operations (2) to perform image processing on the image PB and the like will be discussed. Here, the image processing details related to the image PA are copied and pasted to the different image PB as the image processing details to be provided to the image PB.

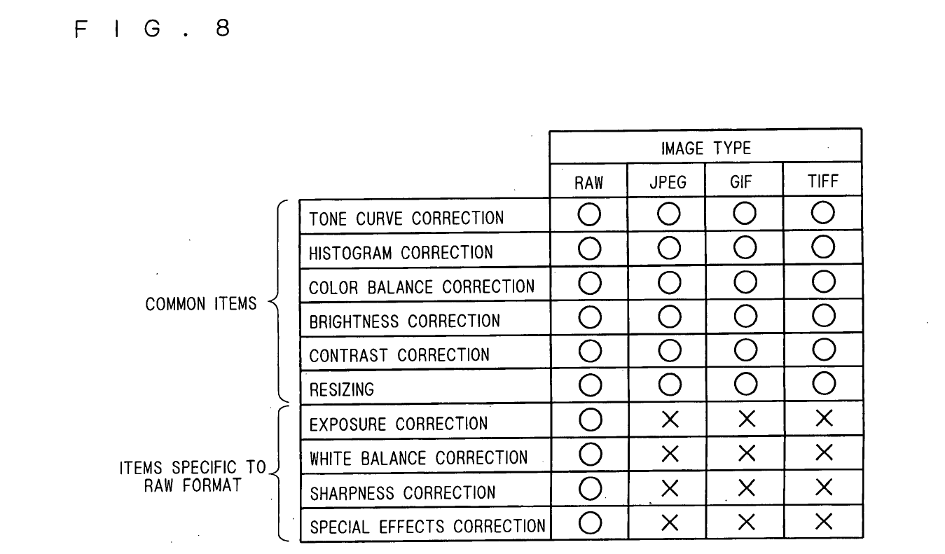

FIG. 7 is a flow chart explaining these operations.

A first step (step S11) is selection of the source image PA of copy editing (here, the image P1) and the like. More specifically, the operator selects the image PA (P1) by a mouse click and presses a copy button 21 on the operation screen 20 (FIG. 3). In response to this selection, the image processing apparatus 1 copies the image processing details with respect to a plurality of items related to the image PA (P1) (more particularly, the value of a correction parameter with respect to each item and the like) and stores the same in the memory. A way of copy editing of image processing details is not limited to the press of the copy button 21. Alternatively, an operation using a program menu (which may for example be selection of an item “copy” from an edit menu), or an operation using a right-click context menu by a mouse (which may for example be selection of an item “copy” from the context menu) is applicable.

The next step (step S12) is selection of the destination image PB (here, the image P8) of paste editing and the like. More specifically, the operator selects the image PB (P8) to which image processing details are to be applied (pasted), and gives an instruction to perform paste editing of the image processing details. Still more specifically, the operator selects the image PB (P8) using a mouse and presses a paste button 22 on the operation screen 20 (FIG. 3). In response to this selection, the image processing apparatus 1 specifies the destination image PB (P8) of paste editing, and follows the operations in steps S13 through S18. A way of paste editing of image processing details is not limited to the press of the paste button 22. Alternatively, an operation using a program menu (which may for example be selection of an item “paste” from an edit menu), or an operation using a right-click context menu by a mouse (which may for example be selection of an item “paste” from the context menu) is applicable.

The image processing apparatus 1 is capable of processing various types of images (still images) such as images of the RAW, JPEG, GIF, TIFF, JPEG2000 formats.

A RAW image directly records output information from in an imaging device (an image sensor), and a detailed data format thereof depends on the color filter arrangement in an imaging device, for example. An image of the RAW format includes unprocessed information directly sent from an imaging device and thus, can be subjected to image processing while maintaining high image quality. The RAW format has superiority over general-purpose formats in that development parameters (including for example an exposure correction parameter, a white balance correction parameter and the like) can be suitably set after image capturing to perform image processing. The RAW format is used to obtain the enhanced quality of an output image.

The JPEG, GIF, TIFF and JPEG2000 formats are general-purpose formats commonly used to display images with no dependence on the color filter arrangement in an imaging device, for example. Images of these general-purpose formats (which more particularly the JPEG, GIF, TIFF and JPEG2000 formats) may also be explained as the products resulting from calculation of three color components ((R, G, B) or (Y, Cr, Cb)) on a pixel unit basis of an image according to the output information from an imaging device (which may be a CCD or a CMOS, for example). These general-purpose formats are divided into those requiring compression and those requiring no compression.

Here, it is assumed that an image of a type different from that of the image PA is selected as the destination image PB of paste editing (which may also be referred to as an objective image). More specifically, it is assumed that the image processing details of the image PA of the RAW format are specified as the possible image processing details to be provided to the image PB of the JPEG format. As discussed, in the image processing apparatus 1, items capable of being shared between a plurality of different types of images are copied to set the image processing details to be provided to each image. Although not to be discussed, the image processing apparatus 1 allows copy-and-paste editing of image processing details to and from images of the same type, in which case the set items related to the image PA are all applied as the image processing details to be provided to the image PB.

In the following, setting operations of image processing details between images of different types will be discussed.

First, the image processing apparatus 1 obtains the type of the destination image PB of paste editing in step S13 of FIG. 7. Here, information indicating that the image PB is of the JPEG format is obtained. As a more specific example, the type of the image PB is recognized by using the filename extension of the image PB and/or tag information in the file of the image PB.

Subsequently, while judging the applicability of each processing item to paste editing, the processing details to be provided to the image PB are set in steps S14 through S17.

More specifically, a processing item targeted for judgment is selected from a plurality of items in image processing related to the image PA (step S14).

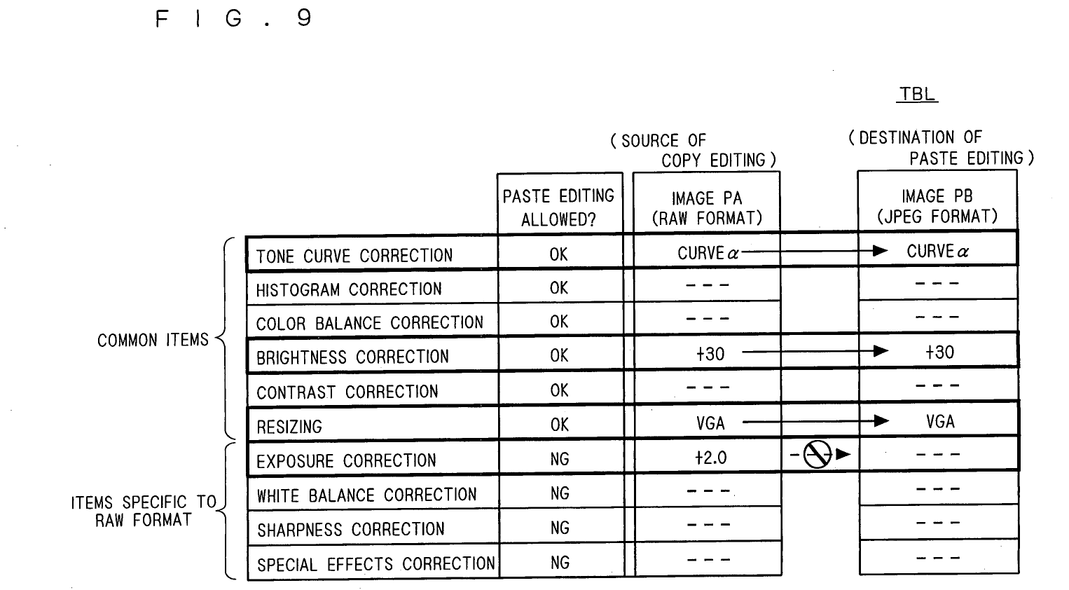

Next, it is judged whether the selected item in image processing is applicable to the destination image PB of paste editing (step S15). This judgment is more specifically made on the basis of the image type obtained in step S13. In other words, each processing item is judged by the applicability both to a source image of copy editing and to a destination image of paste editing. As a specific example, a data table TBL of FIG. 8 and the like showing the applicability of image processing with respect to each item to each image type is stored in the storage part 3. Based on the data table TBL, the applicability of image processing with respect to each item to the destination image PB of paste editing is judged.

As discussed, of a plurality of items shown in FIG. 5, image processing with respect to four items (exposure correction, white balance correction, sharpness correction and special effects correction) are applicable only to an image of the RAW format. The other six items (tone curve correction, histogram correction, color balance correction, brightness correction, contrast correction and resizing) are applicable both to an image of the RAW format and to an image of another format (such as the JPEG format, for example).

If the destination image PB of paste editing is of the JPEG format, it is thus judged that the four image processing with respect to the four items (exposure correction, white balance correction, sharpness correction and special effects correction) are not applicable to the image PB. In this case, the flow bypasses step S16 and proceeds to step S17.

The image processing with respect to the remaining six items (tone curve correction, histogram correction, color balance correction, brightness correction, contrast correction and resizing) are judged to be applicable to the image PB. In this case, the flow proceeds to step S16 where it is determined image processing with respect to these six items are applied to the destination image PB of paste editing, and processing parameters with respect to these processing items are applied as processing parameters for the image PB.

In step S17, it is determined whether judgment of all the items in image processing related to the image PA is completed. If there remains an unjudged processing item, the flow returns to step S14 to repeat the same process steps. When it is determined all the processing items have been subjected to judgment, the flow proceeds to step S18.

In step S18, following the same processing details related to the image PA, the image PB is subjected to image processing with respect to the items judged to be applicable to the image PB. Then, image processing details with respect to a plurality of items are collectively performed on the image PB.

FIG. 9 shows exemplary setting of image processing details. With reference to FIG. 9, it is assumed that the image processing details provided to the image PA with respect to four items in image processing (which more particularly include tone curve correction, brightness correction, resizing and exposure correction) are to be applied as the image processing details to be provided to the image PB.

According to the foregoing process flow, “exposure correction” as an item specific to the RAW format is judged to be inapplicable to the destination image PB of paste editing and hence, no image processing with respect to “exposure correction” is performed on the image PB.

The three items including tone curve correction, brightness correction and resizing are judged to be applicable to another type of image except the RAW format. Thus, the image processing details of the image PA with respect to these items are applied as the processing details to be provided to the image PB. Namely, the image processing details related to the image PA are copied and pasted to the image PB. More specifically, as to “brightness correction”, a value “+30” as a processing parameter related to the image PA is applied as a processing parameter to be provided to the image PB. As to “resizing”, “VGA size (640×480 pixels)” as a processing parameter related to the image PA is applied as a processing parameter to be provided to the image PB. As to “tone curve correction”, “CURVE α” as a processing parameter related to the image PA is applied as a processing parameter to be provided to the image PB. The parameter “CURVE α” represents a group of values representing a correction curve in tone curve correction.

As discussed, the image processing details provided to the image PA can be specified by copy-and-paste editing as the possible image processing details to be provided to the image PB. The image processing apparatus 1 obtains the type of the objective image PB, and sets the image processing details to be provided to the objective image PB according to the image type thus obtained. More specifically, it is assumed that a plurality of items in image processing specified with the possible image processing details include both an item inapplicable to the objective image PB (of the JPEG format, for example) while being applicable to an image of a type (such as the RAW format) different from the type of the objective image PB such as “exposure correction”, and an item applicable to the objective image PB such as “brightness correction”. In this case, with respect only to the item applicable to the objective image PB, the possible image processing details (namely, the processing details provided to the image PA) are applied as the image processing details to be provided to the objective image PB.

Accordingly, in setting the image processing details to be provided to the objective image PB, setting operations of image processing details (set values) required for the image PA are not necessary, thereby realizing considerable simplicity of operations. Especially in the case where the images PA and PB are of different types, with respect to the item applicable to the image PB as well as to the image PA, the image processing details similar to those of the image PA can be applied to the objective image PB by simple operations.

Preferably, image processing details provided to each image are automatically stored as historical information. In image processing of a certain image, by making use of the image processing details (historical information) provided to another image, the certain image can be easily subjected to specific processing in addition to these processing details. Alternatively, when a certain image is to be subjected to additional image processing, by making use of historical information displayed on the display part 5 to see the image processing details provided to this image, additional details in image processing to be provided to the certain image can be efficiently determined. A historical information may be stored in a file separate from a file storing images, or alternatively, may be stored as part of the image file.

### OTHER EXAMPLES

The applicability of the present invention is not limited to the preferred embodiment described so far.

In the preferred embodiment described above, one image is selected as a destination image of paste editing. Alternatively, a plurality of images may be selected as destination images of paste editing. As an example, using the foregoing copy-and-paste editing, a plurality of images including P2 through P9 are selected as destination images of paste editing, and the image processing details related to the image P1 may be applied to each one of the images P2 through P9. This provides enhanced efficiency in setting image processing details.

In the preferred embodiment described above, a source image of copy editing is provided with image processing parameters manually set. Alternatively, a source image of paste editing may be provided with image processing parameters set by the foregoing copy-and-paste editing. As an example, the image P8 as a destination image of paste editing in the foregoing description may also be selected as a source image of copy editing, in which case a different image P10 (not shown) is selected as a destination image of paste editing to follow the same processing as discussed.

In the preferred embodiment described above, the image processing details related to the image P1 of the RAW format are applied as the image processing details to be provided to the image P8 of the JPEG format. However, a source image of copy editing and a destination image of paste may be of alternative types, respectively.

As an example, the image processing details related to an image of the RAW format may be applied as the image processing details to be provided to an image of another general-purpose format (which may be the TIFF format, for example).

Of the source image PA of copy editing and the destination image PB of paste editing (objective image), one may be a moving image whereas the other may be a still image. More specifically, one may be an MPEG image whereas the other may be a JPEG image. By way of example, the image processing details related to the source image of copy editing may include a processing item peculiar to the MPEG format for changing the degree of image compression. In this case, with respect to an applicable processing item (such as resizing) except the item peculiar to the MPEG format, the image processing details related to the source image PA of copy editing can be applied as the image processing details to be provided to the destination image PB of paste editing (objective image) which is a still image of the JPEG format.

Of the source image PA of copy editing and the destination image PB of paste editing, one may be a moving image of a first format whereas the other may be a moving image of a second format. More specifically, one may be a moving image of the MPEG format whereas the other may be a moving image of the Motion JPEG format. By way of example, the image processing details related to the source image of copy editing may include a processing item peculiar to the MPEG format for changing the degree of image compression. In this case, with respect to an applicable processing item except the item peculiar to the MPEG format, the image processing details related to the image PA of copy editing can be applied as the image processing details to be provided to the destination image PB of paste editing.

Likewise, in other examples, the type of a destination image of paste editing is obtained and based on the foregoing data table discussed above, for example, the applicability of processing with respect to each item to this type can be judged. With respect to one of a plurality of items applicable to the type of a destination image of paste editing, the image processing details related to a source image of copy editing can be applied as the image processing details to be provided to a destination image of paste editing.

The applicability of image processing with respect to each item to each image type may be judged according to whether an image can be subjected to this image processing in consideration for example of whether or not information is peculiar to the RAW format. However, the applicability of each item may differ according to various types of circumstances such as those in a program. In any case, as long as these circumstances are reflected in a data table such as the one shown in FIG. 8, for example, the applicability of image processing with respect to each item to each image type can be suitably judged.

In the preferred embodiment described above, the press of the paste button 22 causes not only paste editing of image processing details but also causes image processing sequentially according to the details thus pasted. Alternatively, the press of the paste button 22 may cause only paste editing, in which case execution of actual image processing may be started by pressing another button for giving an instruction to start execution.

In the preferred embodiment described above, the image processing details provided to the image PA are specified as the possible image processing details to be provided to the objective image PB (namely, the possible image processing details to be provided to the objective image PB are specified using the image PA). Alternatively, without using the settings related to the image (also referred to as “processed image”) PA, the possible image processing details to be provided to the objective image PB may be specified as discussed below using for example the operation screen 30 that specifies possible image processing details of an image.

More specifically, with reference to FIG. 3, a plurality of images are selected as the objective images PB using the thumbnail display in the region R2. At this time, a plurality of images to be selected can be of different image types. Alternatively, only one image may be selected.

By means of a mouse operation or the like, an item “image processing detail setting” (not shown) is selected from a context menu (as a right-click menu of a mouse) or from a program menu (displayed in a menu bar), whereby the operation screen 30 shown in FIG. 4 appears.

An operator selects a desirable item from a plurality of items displayed in the item display region R5 on the operation screen 30 to specify the processing details with respect to each item. At this time, regardless of the type of images selected as the objective images PB, the operator can specify the processing details (processing parameter) with respect to each item. As an example, the operator can specify the processing details with respect both to “bright correction” and to “exposure correction” as possible processing details.

The images selected as the objective images PB may include those of image types to which image processing with respect to these two items are not applicable. In this case, the image processing apparatus 1 judges such inapplicability, and with respect only to those items applicable to the objective images PB, applies the processing details specified by using the operation screen 30 as the image processing details to be provided to the objective images PB.

More specifically, when the objective images PB are of types such as the JPEG format (other than the RAW format), the image processing apparatus 1 applies the (possible) processing details with respect only to “brightness correction” specified by using the operation screen 30 as the image processing details to be provided to the objective images PB, without applying the details with respect to “exposure correction”. In this case, the details specified with respect to “exposure correction” is disregarded. When the objective images PB are of the JPEG format, “brightness correction” is expressed as an item applicable to the objective images PB, whereas “exposure correction” is expressed as an item inapplicable to the objective images PB while being applicable to an image of a type (which is more particularly the RAW format) different from that of the objective images PB.

When the objective images PB are of the RAW format, the (possible) processing details with respect both to brightness correction and to exposure correction specified by using the operation screen 30 are directly applied as the image processing details to be provided to images PB.

As discussed, the operator specifies the processing details with respect to a desirable item regardless of the type of an objective image. Then the image processing apparatus 1 judges the applicability of image processing with respect to each item to each image type, in response to which the processing details with respect to each item are applied. Accordingly, image processing details can be efficiently set. Even when a plurality of images of different types are selected as the objective images PB, the processing details with respect to a plurality of items including common items such as “brightness correction” and items specific to the RAW format such as “exposure correction” are collectively specified, and the image processing apparatus 1 judges the applicability of image processing with respect to each item to each image type, thereby setting the processing details to be provided to each image. This provides considerably high efficiency in setting operations.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus, comprising:
a selecting part for selecting an objective image of image processing;
a specifying part for specifying possible image processing details to be provided to said objective image; and
a setting part for setting image processing details to be provided to said objective image based on said possible image processing details specified by said specifying part,
wherein when a plurality of items in image processing specified with said possible image processing details include both an item inapplicable to said objective image while being applicable to an image of a type different from the type of said objective image, and an item applicable to said objective image, said setting part applies the possible image processing details as image processing details to be provided to said objective image with respect only to said item applicable to said objective image.

2. The image processing apparatus according to claim 1,
wherein said specifying part is capable of specifying image processing details provided to a processed image as said possible image processing details, and
wherein when an image of a type different from the type of said processed image is selected as said objective image, of a plurality of items in image processing provided to said processed image, said setting part applies the image processing details provided to said processed image as said image processing details to be provided to said objective image with respect to an item applicable both to said processed image and to said objective image.

3. The image processing apparatus according to claim 2,
wherein of said processed image and said objective image, one is of a type of the RAW format directly recording output information from an imaging device whereas the other is of a type of a predetermined format as a product resulting from calculation of three color components on a pixel unit basis based on output information from an imaging device.

4. The image processing apparatus according to claim 2,
wherein of said processed image and said objective image, one is of a type of a moving image whereas the other is of a type of a still image.

5. The image processing apparatus according to claim 2,
wherein of said processed image and said objective image, one is of a type of a moving image of a first format whereas the other is of a type of a moving image of a second format different from said first format.

6. An image processing method, comprising the steps of:
a) selecting an objective image of image processing;
b) specifying possible image processing details to be provided to said objective image; and
c) setting image processing details to be provided to said objective image based on said possible image processing details specified in said step b),
wherein in said step c), when a plurality of items in image processing specified with said possible image processing details include both an item inapplicable to said objective image while being applicable to an image of a type different from the type of said objective image, and an item applicable to said objective image, the possible image processing details are applied as image processing details to be provided to said objective image with respect only to said item applicable to said objective image.

7. The method according to claim 6,
wherein in said step b), image processing details provided to a processed image is capable of being specified as said possible image processing details, and
wherein in said step c), when an image of a type different from the type of said processed image is selected as said objective image, of a plurality of items in image processing provided to said processed image, the image processing details provided to said processed image are applied as image processing details to be provided to said objective image with respect to an item applicable both to said processed image and to said objective image.

8. The method according to claim 7,
wherein of said processed image and said objective image, one is of a type of the RAW format directly recording output information from an imaging device whereas the other is of a type of a predetermined format as a product resulting from calculation of three color components on a pixel unit basis based on output information from an imaging device.

9. The method according to claim 7,
wherein of said processed image and said objective image, one is of a type of a moving image whereas the other is of a type of a still image.

10. The method according to claim 7,
wherein of said processed image and said objective image, one is of a type of a moving image of a first format whereas the other is of a type of a moving image of a second format different from said first format.

11. A program product causing a computer to execute the following steps of:
a) selecting an objective image of image processing;
b) specifying possible image processing details to be provided to said objective image; and
c) setting image processing details to be provided to said objective image based on said possible image processing details specified in said step b),
wherein in said step c), when a plurality of items in image processing specified with said possible image processing details include both an item inapplicable to said objective image while being applicable to an image of a type different from the type of said objective image, and an item applicable to said objective image, the possible image processing details are applied as image processing details to be provided to said objective image with respect only to said item applicable to said objective image.

12. The program product according to claim 11,
wherein in said step b), image processing details provided to a processed image is capable of being specified as said possible image processing details, and
wherein in said step c), when an image of a type different from the type of said processed image is selected as said objective image, of a plurality of items in image processing provided to said processed image, the image processing details provided said processed image are applied as image processing details to be provided said objective image with respect to an item applicable both to said processed image and to said objective image.

13. The program product according to claim 12,
wherein of said processed image and said objective image, one is of a type of the RAW format directly recording output information from an imaging device whereas the other is of a type of a predetermined format as a product resulting from calculation of three color components on a pixel unit basis based on output information from an imaging device.

14. The program product according to claim 12,
wherein of said processed image and said objective image, one is of a type of a moving image whereas the other is of a type of a still image.

15. The program product according to claim 12,
wherein of said processed image and said objective image, one is of a type of a moving image of a first format whereas the other is of a type of a moving image of a second format different from said first format.
